(19) United States
(12) Patent Application Publication
(10) Pub. No.: US 2026/0027996 A1
(43) Pub. Date: Jan. 29, 2026

(54) Compressed Air Cleaning System

(71) Applicant: Fayez Raydan, Edmonton (CA)

(72) Inventor: Fayez Raydan, Edmonton (CA)

(21) Appl. No.: 18/785,218

(22) Filed: Jul. 26, 2024

(51) Int. Cl. B60S 3/04; B08B 1/12; B08B 1/40; B08B 3/02; B08B 5/02; B60S 1/66

(52) U.S. Cl. CPC B60S 3/04; B08B 1/12; B08B 1/40; B08B 3/02; B08B 5/02; B60S 1/66

(57) ABSTRACT

A compressed air cleaning system includes a housing containing a power source, a microcontroller operably connected to user controls, an air tank, a liquid tank, one or more pumps, and a connector mechanism. The air tank receives air from a compressed air supply and the liquid tank receives water from a water supply. A separate inlet can be used to add detergents and other cleaning chemicals to the water tank. The connector mechanism allows for the use of attachments including different liquid nozzles, air nozzles, and brush assemblies. The microcontroller and user controls allow the user to control various operating parameters of the cleaning system. The system can also include a motor, a drivetrain, and wheels, allowing the housing to move along the ground or along a track system. In this way, the system can be utilized to effectively blow dirt and debris off parked vehicles.

### BACKGROUND OF THE INVENTION

The present invention relates to systems for cleaning vehicle exteriors. The present invention provides a compressed air cleaning system that utilizes compressed air and optional water and cleaning materials to blow dirt, dust, and debris away from the exterior surface of vehicles. The system further allows for multiple mounting options and can be also self-powered to move around a parking lot to clean multiple parked vehicles.

It is important to keep vehicle exterior surfaces clean for several reasons. Individuals often prefer their vehicle to have a clean and aesthetically pleasing appearance. For car dealerships, it is desirable to maintain and thoroughly clean the vehicles that are displayed in a parking lot. Doing so will improve the overall appearance of the vehicle and therefore increase the likelihood of a potential purchaser buying the vehicle. Over time, even when a vehicle is parked, dirt and debris can accumulate. In addition to creating an undesirable appearance, the build-up of excess dirt and debris can cause damage to the vehicle's exterior over time if not removed.

Dirt and excess debris can also be hazardous when a vehicle is being driven on the roadway. For example, semitrucks with attached trailers often gather dirt and debris, more so than typical non-commercial vehicles. Working vehicles are often exposed to more dirt and debris as they are used on and around a job site. Such dirt and debris can become dislodged as the vehicle moves along a roadway. The dirt and debris can strike trailing vehicles, potentially causing damage to the vehicle or vehicle accidents to occur.

It can be very time consuming to clean a vehicle exterior surface by hand. The process must be repeated to address new buildup of debris and dirt, which requires additional manpower over time, especially when cleaning multiple vehicles that are parked in a lot. Another potential solution is to drive each vehicle through a stationary carwash. This can also be time consuming, as each vehicle must be driven through the carwash individually before being returned to its parking spot. This can be very inefficient for car dealerships who often have hundreds of parked cars that need to be cleaned. Additionally, larger vehicles such as semitrucks often will be too big to fit in a standard carwash. Some track-mounted compressed air cleaning systems have been designed, but these are typically utilized for cleaning smaller surfaces, and would not be suitable for cleaning multiple vehicles. These systems also typically lack customizable cleaning options. For individuals cleaning their car, the type of cleaning they want to accomplish may vary depending on the nature of the dirt and debris on the vehicle. For example, different cleaning chemicals, brushes, and other factors may change if the user wishes to remove ice or snow from the vehicle rather than typical dirt or dust.

Recognizing these gaps in the current state of the art, the present invention addresses the problem of how to efficiently and quickly clean vehicle exteriors. The present invention provides a compressed air vehicle cleaning system which allows for a combination of compressed air, water, and cleaning chemicals to be directed a vehicle exterior to quickly and easily remove dirt and debris. Such a system can be mounted on wheels so that it may move around to clean multiple vehicles.

In light of the systems and methods disclosed in the known art, it is submitted that the present invention substantially diverges in design elements and methods from the known art and consequently it is clear that there is a need in the art for an improvement in compressed air vehicle cleaning systems. In this regard the instant invention substantially fulfills these needs.

### SUMMARY OF THE INVENTION

In view of the foregoing disadvantages inherent in the known systems for cleaning vehicle exterior surfaces now present in the known art, the present invention provides a compressed air vehicle cleaning system that utilizes compressed air along with water, cleaning chemicals, and different brush attachments to quickly and efficiently blow dirt and other debris from the exterior surface of a vehicle.

It is an objective of the present invention to provide a compressed air cleaning system which includes a housing comprising a power source, a microcontroller, user controls operably connected to the microcontroller, an air tank configured to receive air from a compressed air supply, a liquid tank configured to receive water from a water supply and having a cleaning fluid inlet for receiving a cleaning material, and one or more pumps configured to pump a volume of air and a volume of liquid. A connector is configured to removably secure any one of an air nozzle, a liquid nozzle, and a brush assembly to the housing, whereby the air nozzle is in fluid communication with the air tank, and whereby the liquid nozzle is in fluid communication with the liquid tank. One or more pumps are configured to pump a volume of air from the air supply through the air nozzle and a volume of liquid through the fluid nozzle. The compressed air and fluid can be utilized to blow dirt and debris from the exterior surface of a vehicle.

It is another objective of the present invention to provide a compressed air cleaning system that includes a mounting mechanism allowing it to be secured to the exterior surface of a vehicle. This allows the system to clean the exterior surfaces of the vehicle to which it is mounted, or to clean the exterior surfaces of other vehicles as the vehicle having the mounted cleaning system drives alongside the target vehicle.

It is a further objective of the present invention to provide a compressed air cleaning system that includes wheels mounted to a track system that allows it to be moved along a set path and clean multiple parked vehicles.

It is yet another objective of the present invention to provide a compressed air cleaning system that includes an on-board motor with user controls that allows a user to remotely control the position of the compressed air cleaning system.

It is a further objective of the present invention to provide a compressed air cleaning system with multiple cleaning attachment options so that the system can be used effectively in different seasons, for example, to remove snow in the winter.

It is another objective of the present invention to provide a compressed air cleaning system that will improve the aesthetic appearance of a vehicle without the manpower required for manually cleaning a vehicle's exterior.

It is a further objective of the present invention to provide a compressed air vehicle cleaning system that includes air outlets oriented at different angles in order to more effectively remove dirt and debris from all surfaces of a parked vehicle as the compressed air vehicle cleaning system moves past the parked vehicle.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings.

FIG. 1 shows a diagram of the components of a first embodiment of the compressed air cleaning system.

FIG. 2 shows a top plan view of a first embodiment of the compressed air cleaning system mounted to a vehicle and in use to clean parked vehicles.

FIG. 3 shows a side elevation view of a first embodiment of the compressed air cleaning system mounted to a semitruck and in use to clean a trailer attached to the semitruck.

FIG. 4 shows a diagram of the components of a second embodiment of the compressed air cleaning system.

FIG. 5 shows a perspective view of a second embodiment of the compressed air cleaning system being used to clean multiple parked vehicles.

### DETAILED DESCRIPTION OF THE INVENTION

Reference is made herein to the attached drawings. For the purpose of presenting a brief and clear description of the present invention, the preferred embodiment will be discussed as used for cleaning dirt and debris from vehicle exterior surfaces. The figures are intended for representative purposes only and should not be considered to be limiting in any respect.

Reference will now be made in detail to the exemplary embodiment(s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment.

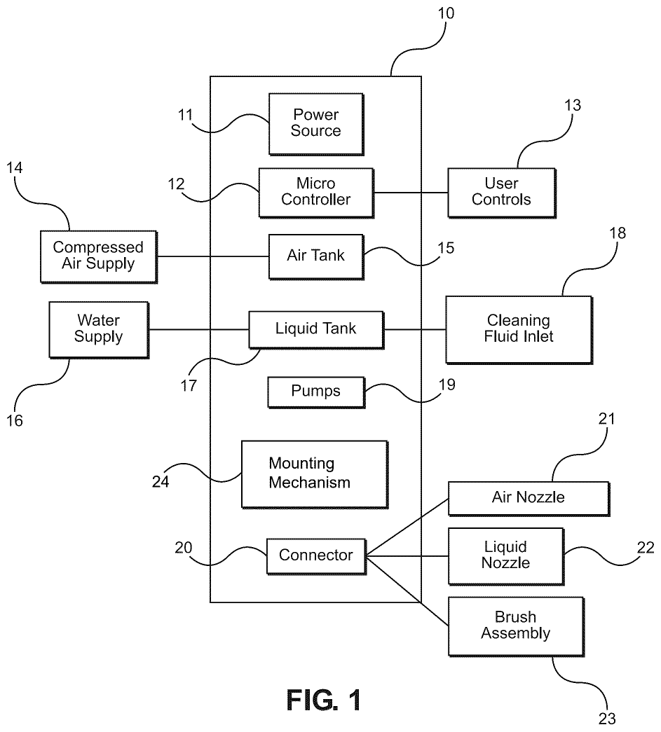

Referring now to FIG. 1, there is shown a diagram of the components of a first embodiment of the compressed air cleaning system. The compressed air cleaning system generally includes a housing 10 which houses a power source 11 that is operably connected to a microcontroller 12. The housing can be made of metals, plastics, and other durable and weather resistant materials. The power source 11 may be a rechargeable battery or any other suitable power source. The microcontroller 12 controls the operations of the compressed air cleaning system. A user control 13 is operably connected to the microcontroller 12 and allows the user to adjust different parameters while controlling the system. The user controls 12 may be onboard buttons, a dedicated remote control unit, a smartphone or similar computing device with the appropriate software installed, or any combination of the foregoing.

The housing 10 further includes an air tank 15 that is configured to receive air from a compressed air supply 14. A connecting hose or similar mechanism can be used to move air into the air tank 15. The housing also includes a liquid tank 17 that is configured to receive water from a water supply 16 via a hose or similar device. The liquid tank 17 may also have a separate cleaning fluid inlet 18 which allows users to add detergents, de-icing chemicals, and other cleaning materials to the liquid tank 17. Pumps 19 operably connected to both the air tank 15 and the liquid tank 17 allow for either air or liquid or a combination of both to be used during the cleaning process. The pumps 19 can be controlled via the user controls 13, allowing the user to utilize the air, liquid, or both.

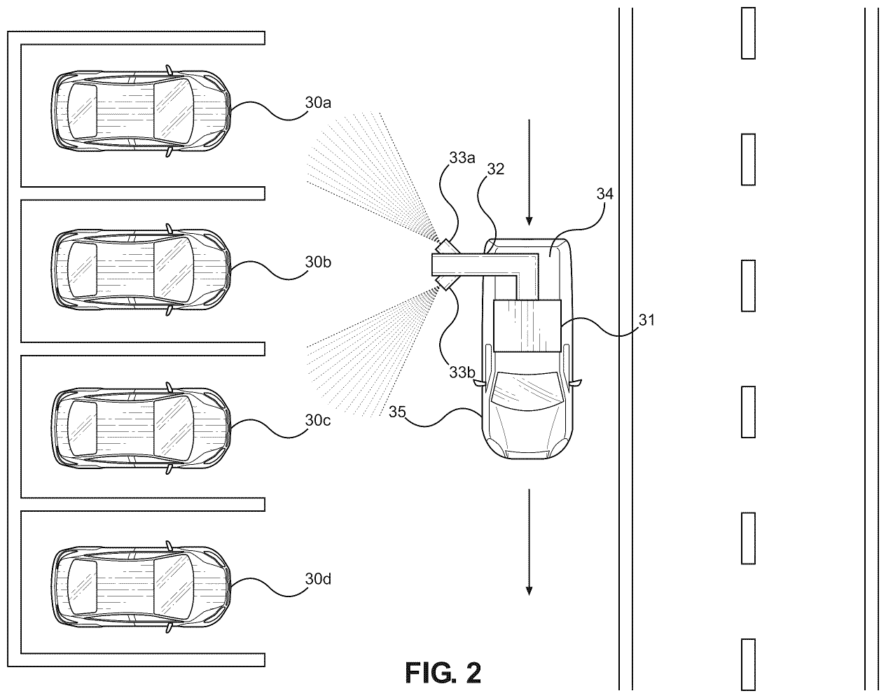

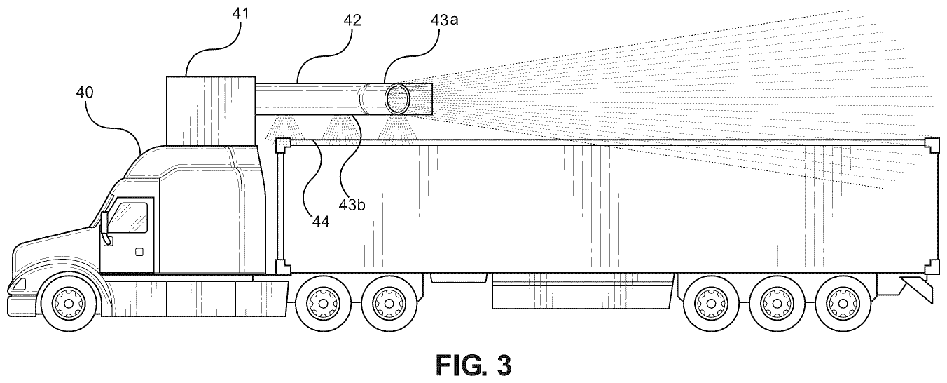

In the shown embodiment, a mounting mechanism 24 allows the housing 10 to be mounted to a desirable surface, such as the ground, or to a roof of a vehicle, as shown in FIGS. 2 and 3. The mounting mechanism 24 can include any combination of mounting devices, including but not limited to adhesives, magnets, or screws and other mechanical mounting methods. A connector 20 is configured to removably secure any one of an air nozzle 21, a liquid nozzle 22, and a brush assembly 23 to the housing. This allows the user to further customize the cleaning actions of the system. The air nozzle 21 is in fluid communication with the air tank 15, and the liquid nozzle 22 is in fluid communication with the liquid tank 17, such that the pumps 19 transport air and liquid to their respective nozzles. The brush assembly 23 can include static or moving brushes. In one embodiment, a shovel assembly is configured to attach to the connector 20. The shovel assembly includes a shovel head that is adapted to bear against a surface of the vehicle and push snow, ice, and the like from that surface. The shovel assembly is used for heavy snow, when the more force is needed to be imparted onto the snow and the like than the air nozzle 21 or liquid nozzle 22 typically outputs.

Referring now to FIG. 2, there is shown a top plan view of a first embodiment of the compressed air cleaning system mounted to a vehicle and in use to clean parked vehicles. The housing 31 is mounted to the roof 34 of a vehicle 35. The air nozzles 32 may include a plurality of outlets 33a, 33b through which compressed air flows. In operation, the vehicle 35 is driven alongside a row of parked vehicles 30a, 30b, 30c, 30d. The system can also include liquid nozzles and brush assemblies which contact the parked vehicles 30a, 30b, 30c, 30d. In the shown embodiment, the air outlets 33a, 33b are positioned such that they are angled in an opposite direction from one another. This increases the effective area which the system can clean from a single position, thereby increasing overall efficiency.

Referring now to FIG. 3, there is shown a side elevation view of a first embodiment of the compressed air cleaning system mounted to a semitruck and in use to clean a trailer attached to the semitruck. In the shown embodiment, the housing 41 is mounted to the roof of the semitruck 40. In this embodiment, the compressed air supply for the system may be the vehicle's integrated onboard compressed air tank, which is normally used in connection with the vehicle's braking system. The air nozzle 42 extends rearwardly overtop and proximal to a trailer 44 that is attached to the semitruck 40. The air outlets 43a, 43b are angled in different directions in order to clean multiple areas of the trailer 44 simultaneously. For example, air outlet 43a can blow air across the top of the trailer 44 while the air outlets 43b can blow down along the sides of the trailer. This embodiment can also include different brushes and liquid nozzles to further clean the semitruck 40 and trailer 44. Additionally, this system may be used on a variety of vehicle types, including cars, SUVs, trucks, and the like.

In one embodiment, the compress air cleaning system is mounted to the trailer portion of the vehicle. When mounted thereon, one or more wheels engage with the sides and/or roof of the trailer to ride therealong and are joined via a bracket to form a carriage. The carriage is connected to a similar carriage on the opposite side of the trailer, such that the carriages are linked and travel between a front and rear end of the trailer to remove snow, ice, debris, and the like along the way. The wheels are actuated by the same air system that is linked to the air nozzle. In some embodiments, the compress air cleaning system is fitted to a roof of a vehicle, such as a passenger two or four door car.

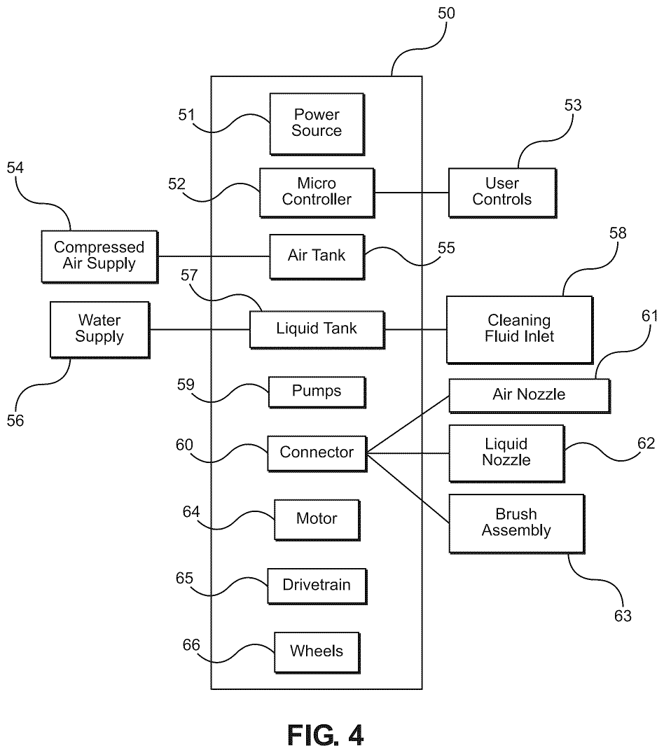

Referring now to FIG. 4, there is shown a diagram of the components of a second embodiment of the compressed air cleaning system. This embodiment of the compressed air cleaning system includes a housing 50 having a power source 51, a microcontroller 52, user controls 53 operably connected to the microcontroller 52, an air tank 55 configured to receive air from a compressed air supply 54, a liquid tank 57 configured to receive water from a water supply 56 and cleaning chemicals via a cleaning fluid inlet 58, multiple pumps 59, and a connector 60 that allows for connection of different air nozzles 61, liquid nozzles 62, and brush assemblies 63. In the shown embodiment, the system also includes a plurality of wheels 66 that allow the housing 50 to move along the ground or along a track configured to receive the wheels 66. The wheels 66 may rotate freely, allowing the housing 50 to be moved manually or with assistance from an external machine, such as a pulley system, for example. In the shown embodiment, the housing 50 also includes a motor 64 which is powered by the power source 51. The motor 64 is operably connected to a drivetrain 65, which is in turn operably connected to the wheels 66, allowing the motor 64 to power the wheels 66. In this embodiment, the user controls 53 can be utilized to control the motor 64 and therefore the movement and ultimate position of the housing 50.

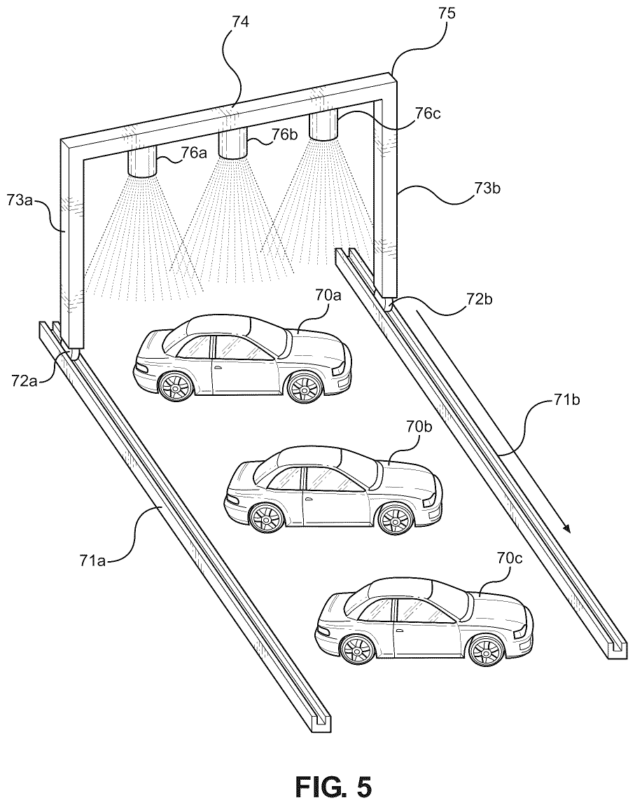

Referring now to FIG. 5, there is shown a perspective view of a second embodiment of the compressed air cleaning system being used to clean multiple parked vehicles. In the shown embodiment, the housing 75 further comprises a pair of supports 73a, 73b which are connected via an upper carriage 74. The air outlets 76a, 76b, 76c are positioned such that they are parallel to one another and extend downwardly toward the ground in a direction that is generally perpendicular to the upper carriage 74 and perpendicular to the ground surface. The connector (not visible) is configured to position the air nozzles such that they extend downwardly from the upper carriage 74. In the shown embodiment, the system also includes a plurality of tracks 71a, 71b installed on a ground surface. Each track 71a, 71b is configured to receive at least one of the wheels 72a, 72b, such that each wheel 72a, 72b is moveably secured within one of the tracks 71a, 71b. The tracks are positioned such that the system can be moved across an area where parked vehicles 70a, 70b, 70c are located beneath the upper carriage 74. The air outlets 76a, 76b, 76c can then blow air downwardly onto the parked vehicles 70a, 70b, 70c to remove dirt and debris as they pass over the vehicles. In other embodiments, the system can also include water nozzles and brush assemblies that further clean the parked vehicles 70a, 70b, 70c as the upper carriage 74 moves overtop of them.

Other embodiments of the compressed air cleaning system can be utilized for different purposes. For example, one embodiment of the compressed air cleaning system can include a smaller housing with an enclosed area surrounding the connector and any connected air outlets, liquid outlets, or brush assemblies. A canine or similar animal can be secured such that its body is within the housing and its head emerges through an opening. The compressed air and liquid can then be directed toward the canine to automatically bathe it. Other embodiments may be utilized for other purposes. For example, the cleaning system may be made portable for cleaning household surfaces such as toilets and the like.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A compressed air cleaning system, comprising:
a housing comprising:
a power source;
a microcontroller;
user controls operably connected to the microcontroller;
an air tank configured to receive air from a compressed air supply;
a liquid tank configured to receive water from a water supply and having a cleaning fluid inlet for receiving a cleaning material; and
a connector configured to removably secure any one of an air nozzle, a liquid nozzle, and/or a brush assembly to the housing;
whereby the air nozzle is in fluid communication with the air tank, and whereby the liquid nozzle is in fluid communication with the liquid tank;
wherein one or more pumps are configured to pump a volume of air from the air supply through the air nozzle and a volume of liquid through the fluid nozzle.

2. The compressed air cleaning system of claim 1, wherein the housing comprises a mounting mechanism configured to secure the housing to an exterior surface of a vehicle.

3. The compressed air cleaning system of claim 2, wherein the compressed air supply is integrated into the vehicle to which the housing is mounted.

4. The compressed air cleaning system of claim 1, wherein the user controls are configured to control the activation of the one or more pumps.

5. The compressed air cleaning system of claim 1, wherein the housing further comprises a pair of supports connected via an upper carriage.

6. The compressed air cleaning system of claim 5, wherein the connector is configured to position the air nozzle such that it extends downwardly from a lower surface of the upper carriage.

7. The compressed air cleaning system of claim 5, wherein the housing further comprises a plurality of wheels.

8. The compressed air cleaning system of claim 7, further comprising a plurality of tracks installed on a ground surface, wherein each wheel of the plurality of wheels is configured to be moveably secured within one track of the plurality of tracks.

9. The compressed air cleaning system of claim 1, wherein the housing further comprises a motor operably connected to the power source, a drive train operably connected to the motor, and a plurality of wheels operably connected to the drive train.

10. The compressed air cleaning system of claim 9, wherein the user controls are configured to control the motor.

11. The compressed air cleaning system of claim 1, wherein the power source is a rechargeable battery.

12. The compressed air cleaning system of claim 1, wherein the air nozzle comprises a plurality of outlets through which compressed air flows.

13. The compressed air cleaning system of claim 12, wherein at least two outlets of the plurality of outlets are positioned such that they are angled in an opposite direction from one another.

14. The compressed air cleaning system of claim 12, wherein at least two outlets of the plurality of outlets are positioned such that they extend parallel to one another.

15. The compressed air cleaning system of claim 12, wherein at least one outlet of the plurality of outlets is positioned such that it is oriented perpendicular to a ground surface.
